(19) United States
(12) Patent Application Publication
(10) Pub. No.: US 2022/0283777 A1
(43) Pub. Date: Sep. 8, 2022

(54) SIGNED MULTIWORD MULTIPLIER

(71) Applicant: Google LLC, Mountain View, CA (US)

(72) Inventor: Reiner Pope, Mountain View, CA (US)

(21) Appl. No.: 17/637,531

(22) PCT Filed: Aug. 20, 2020
(86) PCT No.: PCT/US2020/047147

§ 371 Date: Feb. 23, 2022

Related U.S. Application Data
(60) Provisional application No. 62/890,932, filed on Aug. 23, 2019.

(51) Int. Cl. G06F 7/48; G06F 7/544; G06F 7/523; G06F 7/50; G06F 5/01

(52) U.S. Cl. CPC G06F 7/4824; G06F 7/5443; G06F 7/523; G06F 7/50; G06F 5/01

(57) ABSTRACT

Methods, systems, and apparatus, including computer programs encoded on a computer storage medium, for a hardware circuit configured as a signed multiword multiplier. The circuit includes a processing circuit that receives inputs that each have a respective bit-width. The processing circuit can represent at least one input as a signed multiword input based on the first input having a bit-width that exceeds a fixed bit-width of the hardware circuit. The circuit includes signed multipliers that are each configured to multiply signed inputs. Each signed multiplier includes multiplication circuitry configured to: receive the signed multiword input; receive a signed second input; and generate a signed output in response to multiplying the signed multiword input with the signed second input.

### BACKGROUND

This specification relates to hardware circuits for performing mathematical computations.

Computational circuits can include multiplication circuits with hardware multipliers that are used to multiply numerical inputs such as integers and floating-point numbers. Multiplication circuits can be expensive to procure and integrate into an existing computing circuit and some circuits are not efficiently sized for certain applications. For example, some multiplication circuits can include both signed multipliers and unsigned multipliers that consume a substantial area of a circuit die but provide no advantage in computing throughput despite their large size. Multiplier circuits that are oversized for certain computing applications can cause inefficiencies in power consumption and utilization.

A hardware circuit can be used to implement a neural network. In particular, a neural network having multiple layers can be implemented on a computational circuit that includes several hardware multipliers. Computational circuitry of the hardware circuit can also represent a computation unit that is used to perform neural network computations for a given layer. For example, given an input, the circuitry can compute an inference for the input using the neural network by performing dot product operations using one or more of the multipliers in the computation unit of the hardware circuit.

### SUMMARY

This document describes a special-purpose hardware circuit for multiplying inputs. The hardware circuit includes a processing circuit that receives inputs that each have a respective bit-width. The processing circuit can represent at least one input as a signed multiword input based on the first input having a bit-width that exceeds a fixed bit-width of the hardware circuit. The hardware circuit is configured as a signed multiword multiplier and includes signed multipliers that are each configured to multiply signed inputs. Each signed multiplier includes multiplication circuitry configured to: receive the signed multiword input; receive a signed second input; and generate a signed output in response to multiplying the signed multiword input with the signed second input.

One aspect of the subject matter described in this specification can be embodied in a hardware circuit for multiplying sets of inputs. The hardware circuit includes: processing circuitry that receives a first input and a second input, each of the first and second inputs having a respective bit-width, wherein the processing circuitry is configured to represent at least the first input as a signed multiword input based on the first input having a bit-width that exceeds a fixed bit-width of the hardware circuit; and multiple signed multipliers, each signed multiplier of the multiple signed multipliers being configured to multiply two or more signed inputs, each signed multiplier including multiplication circuitry configured to: receive the signed multiword input that represents the first input; receive a signed second input that corresponds to the second input; and generate a signed output in response to multiplying the signed multiword input with the signed second input.

These and other implementations can each optionally include one or more of the following features. For example, in some implementations, the signed multiword input is a shifted signed number including N words, each N word including B bits; and N is an integer greater than 1 and B is an integer greater than 1. In some implementations, a numerical value of the shifted signed number is defined based on: a0+a1*2^{B}+a2*2^{(2B)}+ . . . + a{N−1}*2^{{(N-1)B}}, wherein a represents a respective signed word of the signed multiword input. In some implementations, a representable numerical range of the shifted signed number is defined based on: [−2^{(N*B-1)}−S, 2^{(N*B-1)}−1−S]. In some implementations, S is defined based on: 2^{(B-1)}*(1+2^{B}+ . . . +2^{{(N-2)B}}). In some implementations, the processing circuitry is configured to represent the first input as a signed multiword input including: a signed high-word portion; and a signed low-word portion.

In some implementations, representing the first input as the signed multiword input includes: using a quantization scheme to modify a data format of the first input based on the fixed bit-width of the hardware circuit. In some implementations, the quantization scheme is configured to modify the data format of the first input by generating respective word portions to represent the first input as the signed multiword input; and a total bit-width that includes each respective word portion is equal to the fixed bit-width of the hardware circuit. In some implementations, the signed multiword input includes multiple respective words; and the multiplication circuitry is configured to generate the signed output by multiplying each word of the signed multiword input with each word of the signed second input. In some implementations, the signed second input includes multiple respective signed words; and the multiplication circuitry is configured to generate the signed output as a sum of respective products that are computed from multiplying each word of the signed multiword input with each signed word of the signed second input.

One aspect of the subject matter described in this specification can be embodied in a method for multiplying sets of inputs using a hardware circuit. The method includes: receiving, by a processing circuit of the hardware circuit, a first input and a second input, each of the first and second inputs having a respective bit-width, wherein at least the first input has a bit-width that exceeds a fixed bit-width of multiplication hardware included in the hardware circuit, the multiplication hardware being used to multiply the first and second inputs; generating, from at least the first input, a signed multiword input including a plurality of signed words that each have a plurality of bits, wherein a bit-width of the signed multiword input is less than the fixed bit-width of the multiplication hardware; providing the signed multiword input and a signed second input to the multiplication hardware for multiplication, wherein the signed second input corresponds to the second input and has a bit-width that is within the fixed bit-width of the multiplication hardware; and generating a signed output from the multiplication hardware using at least the first and second inputs.

These and other implementations can each optionally include one or more of the following features. For example, in some implementations, the signed multiword input is a shifted signed number including N words, each N word including B bits; and N is an integer greater than 1 and B is an integer greater than 1. In some implementations, a numerical value of the shifted signed number is defined based on: a0+a1*2^{B}+a2*2^{(2B)}+ . . . +a{N−1}*2^{{(N-1)B}}, wherein a represents a respective signed word of the signed multiword input. In some implementations, a representable numerical range of the shifted signed number is defined based on: [−2^{(N*B-1)}−S, 2^{(N*B-1)}−1−S]. In some implementations, wherein S is defined based on: 2^{(B-1)}*(1+2^{B}+ . . . +2^{{(N-2)B}}). In some implementations, generating the signed multiword input includes representing the first input as a signed multiword input including: a signed high-word portion; and a signed low-word portion.

In some implementations, representing the first input as the signed multiword input includes: using a quantization scheme to modify a data format of the first input based on the fixed bit-width of the hardware circuit. In some implementations, the method further includes: modifying, based on the quantization scheme, the data format of the first input by generating respective word portions to represent the first input as the signed multiword input, wherein a total bit-width that includes each respective word portion is equal to the fixed bit-width of the hardware circuit. In some implementations, the signed second input includes multiple respective words and the method further includes: generating, using a signed multiplier of the multiplication hardware, the signed output as a sum of the respective products of multiplying each word of the signed multiword input with each word of the signed second input.

Other implementations of this and other aspects include corresponding systems, apparatus, and computer programs, configured to perform the actions of the methods, encoded on computer storage devices (e.g., non-transitory machine-readable storage mediums). A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The subject matter described in this specification can be implemented in particular embodiments to realize one or more of the following advantages. The described techniques can be used to implement a special-purpose hardware circuit for multiplying two or more inputs while requiring less power than conventional circuits that are used to multiply inputs. Components of the hardware circuit described in this document form a signed multiword multiplier circuit having signed multipliers that are configured to multiply signed inputs to generate a signed output. The multiword multiplier can be a low-power hardware multiplication circuit that efficiently multiplies several inputs (e.g., floating-point inputs) based on a unique numerical format for representing signed numbers.

The multiplication circuit can be configured to have multiplication hardware that includes only signed hardware multipliers for performing the multiplication of the inputs. The circuit includes processing circuitry used to generate shifted signed multiword numbers in response to processing inputs that have a conventional numbering format, such as a two's complement format. The signed multiword numbers are multiplied using the signed hardware multipliers to generate a signed output. These features of the multiplication circuit lead to reduced power consumption at the circuit, relative to conventional circuits that multiply inputs. This is because the multiplication is completed using only signed multipliers, rather than both signed and unsigned multipliers. Further, circuits that include hardware multipliers for supporting multiple modes (e.g., signed and unsigned modes) also increases the chip area consumed by the circuit, thereby increasing manufacturing costs of the circuit. So, the proposed techniques provide reductions not just in power consumption, but also manufacturing costs.

When the multiplication hardware of the circuit is configured to include only signed hardware multipliers, the overall hardware circuit consumes much less power than conventional circuits that must include additional multiplication hardware to support both signed and unsigned computation modes. Hence, this low-power hardware multiplier circuit can be optimized for multiplying numerical inputs with reduced power requirements based on at least the signed multiplier configuration that leverages a signed only mode to generate a product of multiplying two or more signed multiword inputs.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 shows a diagram of an example special-purpose hardware circuit for multiplying inputs.

FIG. 2 shows a flow diagram for generating signed multiword inputs that are provided to signed hardware multipliers to generate a signed output.

FIG. 3 shows a flowchart of an example process for multiplying inputs in the described hardware multiplier circuit.

Like reference numbers and designations in the various drawings indicate like elements.

### DETAILED DESCRIPTION

Conventional computer architectures provide multiplication hardware at a fixed bit-width, B. When these architectures need to multiply inputs that have a number of bits that exceed the bit-width, the architectures split the input numbers into multiple pieces (“words”), where each word has a length or bit-width, B. To produce a computational output, these architectures multiply every word of the first input with every word of the second input. However, to produce a signed (e.g., positive, negative, or zero) output, the architectures must be configurable in both a signed mode and an unsigned mode (e.g., where inputs are only positive or zero). Conventional circuits that must be configurable in both the signed mode and an unsigned mode require additional hardware components that translate to increased power consumption.

In an example implementation, a hardware circuit can be used to implement a multi-layer neural network and perform computations (e.g., neural network computations) by processing the input through each of the layers of the neural network. In particular, individual layers of the neural network can each have a respective set of parameters. Each layer receives an input and processes the input in accordance with the set of parameters for the layer to generate an output based on computations that are performed using multiplication circuits of an example computation unit. For example, the neural network layer computes multiple products when performing matrix multiplication of an input array and a parameter array or as part of computing a convolution between an input array and a parameter kernel array.

In general, processing an input through a layer of a neural network is accomplished using circuitry for performing mathematical operations, e.g., multiplication and addition. An example hardware circuit can include hardware multipliers for multiplying two or more inputs. The multiplier circuits can be grouped along with hardware adders to form a computation unit, e.g., for a matrix or vector processing unit, of the hardware circuit. The computation unit is used to add and multiply numerical inputs such as integers and floating-point numbers. For example, the additions and multiplications occur when the hardware circuit is used to perform neural network computations, such as matrix-vector multiplications for processing an input through a layer of a neural network.

Considering the context above, this document describes techniques for implementing a special-purpose hardware circuit for multiplying two or more inputs that are represented as signed multiword inputs. The techniques can be used to represent signed or unsigned inputs as “shifted signed multiword numbers.” These shifted signed multiword numbers use a unique number format to represent received inputs as signed numbers. The received inputs can be individual words of the multiword number, which may also include single-word inputs and multiword inputs. By representing inputs as signed numbers, the special-purpose hardware circuit does not need to support an unsigned mode. Hence, the described hardware circuit uses a more streamlined architecture that includes multiplication circuitry for signed mode operation, rather than operations for both signed and unsigned modes. Because the described hardware circuit is configured for only signed mode operation, the circuit requires fewer components, which translates to improved power efficiency when compared to conventional architectures.

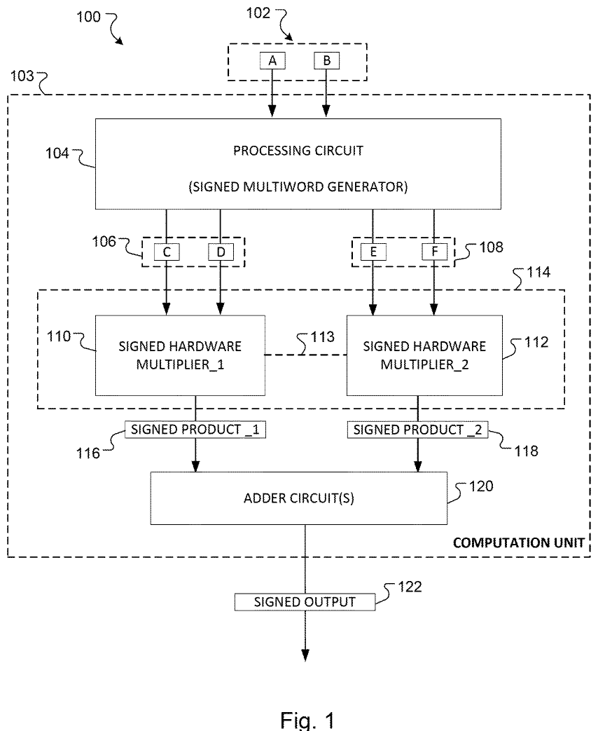

FIG. 1 shows a diagram of an example special-purpose hardware circuit 100 for multiplying inputs 102. In an example implementation, input 102A (“input A”) and 102B (“input B”) are respective floating-point or twos-complement numbers that can be represented in software using a binary data structure. The binary data structure can have a particular number of bits, e.g., a 16-bit, a 24-bit, or a 32-bit data structure. For example, each of inputs A or B can be a respective signed floating-point number and a sign bit(s) for each input can indicate the sign (e.g., positive or negative) of the input.

The data structure of each numerical input can be associated with a particular data format. The data format may indicate a finite range of numerical values that can be represented using the data format. In some implementations, a 16-bit data structure for input A can include binary inputs (e.g., 0010) that represent a two's complement data format of input A. Regarding numerical range, ordinary two's complement numbers can have the following finite representable range of numerical values [−32,768, 32,767]. Further, each numerical input has one or more bits in its data structure that indicates whether the number is a signed number or an unsigned number.

As described in this document, data structures that represent signed numerical inputs (e.g., integers) can hold both positive numerical values (e.g., integer values) and negative numerical values, whereas data structures that represent unsigned numerical inputs can hold a larger range of positive numerical values and no negative numerical values. In general, processor circuits, such as GPUs or neural network processors, often include arithmetic logic units (ALUs) or computation units for performing computations involving different types of inputs, e.g., integers or floating-point inputs.

Computations involving signed inputs correspond to signed mode operations, whereas computations involving unsigned inputs correspond to unsigned mode operations. The ALUs and computation units for performing the computations involving signed and unsigned numerical inputs require distinct sets of hardware components to support the respective signed mode and unsigned mode operations. For example, as described above, some computer architectures provide multiplication hardware at a fixed bit-width, B. When these architectures need to multiply inputs that have a number of bits that exceed the bit-width, the architectures split the input numbers into multiple pieces (“words”), where each word has a length or bit-width, B. To produce a computational output, the architectures multiply every word of the first input with every word of the second input.

But, as discussed previously, to produce a signed (e.g., positive, negative, or zero) output, the architectures must be configurable in both a signed mode and an unsigned mode (e.g., where inputs are only positive). Architectures that must be configurable for both signed and an unsigned operations require additional hardware components that translate to increased power consumption. In this context, techniques are described for implementing a special-purpose hardware circuit 100 that is configured to multiply signed inputs having a unique data format, while consuming less power relative to conventional hardware circuits. The specialized circuit 100 includes multiplication circuitry for supporting only signed mode operations. The circuit achieves certain power savings when the inputs are represented only as signed numbers. For example, by generating computation outputs from multiplying only signed inputs, the circuit 100 can include fewer hardware components and a smaller instruction set with a reduced number of software instructions to multiply inputs.

Circuit 100 includes an input processor 104 that is configured to generate signed multiword inputs. A portion of hardware circuit 100 can include a computation unit 103 with multiplication circuitry that provides hardware multipliers for multiplying inputs 102. The input processor 104 can be configured to generate the signed multiword inputs based on a fixed bit-width of the multiplication circuitry in a computation unit 103 of circuit 100. More specifically, the input processor 104 is configured to generate a shifted signed multiword number from an input 102. For example, the input processor 104 can generate shifted signed multiword numbers 106 and 108. Shifted signed multiword numbers 106 can include respective signed word inputs C and D that are each generated from input A, whereas shifted signed multiword numbers 108 can include respective signed word inputs E and F that are each generated from input B.

The hardware circuit 100 includes signed hardware multipliers 110 and 112. In some implementations, the circuit 100 is configured to include low-power signed integer or floating-point multiplication circuits. In some examples, the multipliers 110, 112 can be connected via an optional connection 113 to form a single, large-scale signed multiplication circuit of hardware circuit 100. In some other examples, multipliers 110 and 112 can represent different hardware multipliers of a larger multiplication circuit 114 and circuit 100 can include one or more multiplication circuits 114. While two multipliers are shown in the example of FIG. 1, the circuit 100 (or circuit 114) can be configured to include more or fewer multipliers. For example, the circuit 100 can include a single multiplier configured to be used over time for multiple purposes to achieve the same (or similar) computational effect as multiple individual multipliers. In this manner, the circuit 100 can be optimized for multiplying certain numerical inputs with reduced power requirements by, for example, including only signed multipliers or other hardware components needed to support only signed mode operations. In some cases, the special-purpose hardware circuit 100 uses the multiplication circuitry to perform computations for processing inputs through layers of a neural network. The computations can include multiplication of inputs and parameters to generate accumulated values that are further processed to generate a layer output of a neural network layer.

In an example operation, given a set of inputs that includes respective signed word inputs C and D (that are each generated from input A) and respective signed word inputs E and F (that are each generated from input B), the circuit 100 is configured to multiply inputs C and E (C*E), multiply inputs C and F (C*F), multiply inputs D and E (D*E), and multiply inputs D and F (D*F). The computation unit 103 includes an adder circuit 120 (“adder 120”) that is configured to perform an appropriate addition operation between products generated by one or more of multipliers 110, 112, of the multiplication circuit 114. The computation unit 103 is configured to perform the addition operation after shifting one or more product values by the necessary bit widths. For example, the computation unit 103 can use the adder 120 to perform the shifting operations (e.g., <<2*B, <<B, etc.) before performing the following addition operations: (C*E<<(2*B))+((C*F+D*E)<<B)+D*F.

Adder 120 receives signed products 116 and 118 as inputs and adds the signed products 116 and 118 to generate a signed output 122 of computation unit 103. In some implementations, a two's complement version of a negative signed product 118 is used to perform the addition operation, which involves adding signed product 116 with the two's complement version of signed product 118, to generate signed output 122. In some cases, adding the inputs can include using rounding logic to perform a rounding operation on a preliminary sum before generating the signed output 122. For example, the rounding logic can be used to round the preliminary sum to a nearest decimal or integer value before generating the signed output 122. In some implementations, the signed output 122 represents accumulated values for generating a layer output of a neural network layer in response to processing numerical inputs 102 through the neural network layer.

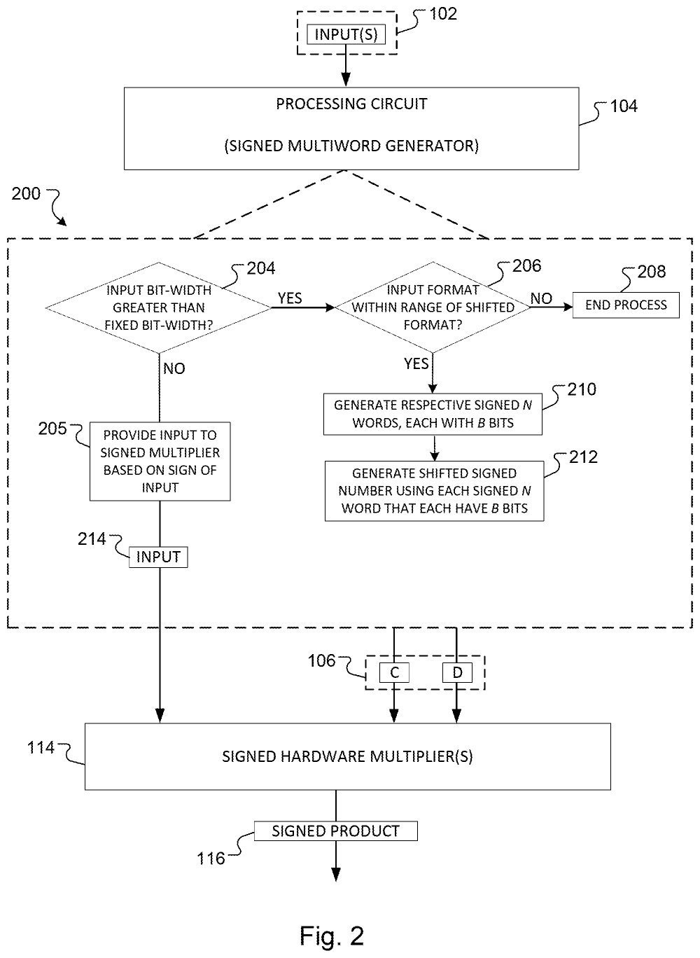

FIG. 2 shows a process diagram 200 for generating signed multiword inputs that are provided to signed hardware multipliers of circuit 100 to generate a signed output 122. As described in more detail below, process diagram 200 includes multiple logic blocks that each represent a respective logic function of the input processor 104. In general, one or more of the respective logic functions may be used to generate shifted signed multiword numbers.

Referring to process diagram 200, the hardware circuit 100 is configured as a signed mode circuit and includes input processing circuitry 104 for generating signed multiword numbers 106. Input processor 104 generates shifted signed multiword numbers from the input 102, based at least on a determination that the input has a bit-width that exceeds a fixed bit-width of a hardware multiplier included at the hardware circuit (204). For example, input processor 104 can analyze the binary data structure of inputs 102 to determine whether each respective input exceeds a fixed bit-width of the multiplication circuitry 114 included in computation unit 103.

Generating the signed multiword numbers 106 includes generating the numbers 106 based on the input processor 104 determining that the inputs 102 are within a predefined numerical range of a data format used to represent the shifted signed multiword numbers 106 (206). For example, the input processor 104 generates the signed multiword numbers 106 in response to determining that a numerical value of the inputs 102, e.g., two's complement numbers, fits within the available numerical range of the data format that represents the shifted signed multiword numbers 106. For a given input 102, if the input processor 104 determines that a numerical value of the input 102 does not fit within the available numerical range of the data format, then input processor 104 ends process 200 (208).

If input processor 104 determines that the inputs 102 are within the predefined numerical range of the data format, the input processor 204 causes one or more of the inputs to be represented as a respective signed multiword input based on at least the first input having a bit-width that exceeds a fixed bit-width of the hardware circuit 100. For example, to represent the input as a signed multiword input, the input processor 104 generates respective signed N words, that each have B bits (210). The input processor 104 then generates a shifted signed number using each signed N word that each have B bits (212). In some implementations, N is an integer greater than 1 and B is an integer greater than 1. The signed multiword inputs are provided to signed hardware multipliers of multiplication circuit 114 to ultimately generate a signed output.

In some cases, the input processor 104 determines that the input 102 has a bit-width that does not exceed a fixed bit-width of a hardware multiplier 110 included at the hardware circuit (205). In this scenario, the input processor 104 provides the input 214 to a signed multiplier of multiplication circuit 114. For example, the input processor 104 can provide the input 214 to a particular hardware multiplier based on the sign of the input matching a sign of the particular hardware multiplier. In this implementation, because the input 214 does not have a bit-width that is greater than a fixed bit-width of the multiplication circuit 114, then input 214 would not be a suitable input for generating signed multiword inputs.

For an example multiplication operation, the determination whether to generate a shifted signed multiword number from an input 102, as well as the subsequent generation of the signed multiword input, can occur relatively early in a compute cycle. For example, the determination can be made off-chip using an external host controller that communicates with circuit 100 to obtain inputs for processing through a neural network layer. In some implementations, the determination and subsequent generation occurs as inputs are obtained from a memory of an example neural network processor, such as an activation memory that stores activations generated by a neural network layer implemented on a neural network processor that includes hardware circuit 100.

In other implementations, the determination of whether to generate a signed multiword input, as well as the subsequent generation of the signed multiword input, can occur in a previous pipeline stage, e.g., at a prior multiplier, an ALU, or a bypass circuit of the computation unit 103. In some cases, an interface of each signed hardware multiplier 110, 112 can be modified or augmented to include a respective input processor 104. In such cases, inputs 102 received at an input of each multiplier 110, 112 can be processed to generate an appropriate number of shifted multiword inputs for multiplication at the respective hardware multipliers 110, 112.

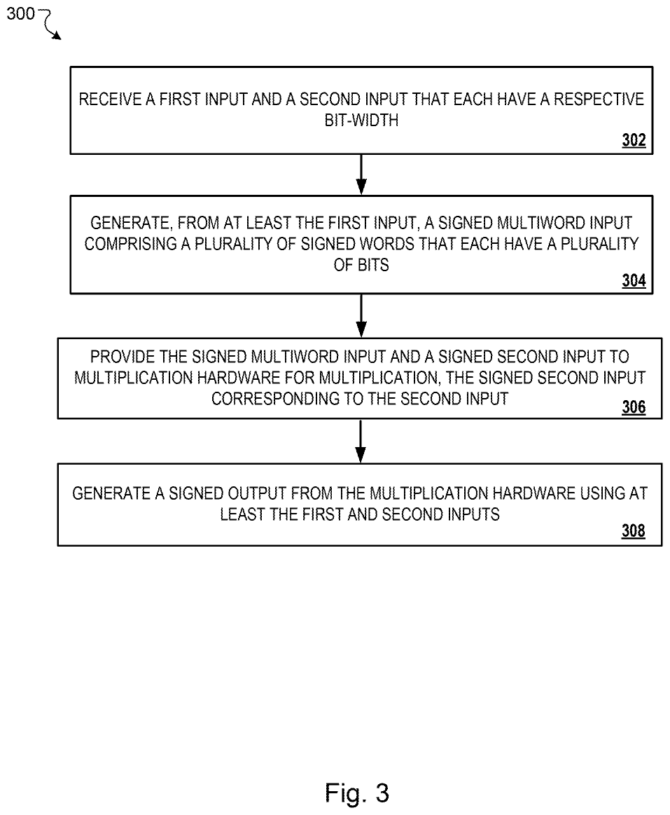

FIG. 3 shows a flowchart of an example process 300 for multiplying inputs using the described hardware multiplier circuit 100. As indicated above, the inputs can be numerical inputs, such as floating-point numbers that are represented as a data structure of bits, e.g., 16-bits or 32-bits. Process 300 can be performed using at least circuit 100 in combination with other circuits, components, and systems described in this document.

Referring now to process 300, the circuit 100 receives a first input and a second input that each have a respective bit-width (302). The processing circuitry is configured to represent at least the first input as a signed multiword input based on the first input having a bit-width that exceeds a fixed bit-width of the hardware circuit. For example, the fixed bit-width of the hardware circuit can be 16-bits, whereas a bit-width for an example data structure of the first input is 32-bits.

The circuit 100 generates, from at least the first input, a signed multiword input that includes multiple signed words that each have multiple bits (304). The signed multiword input/number is a shifted signed number including N words, each N word including B bits. In general, N can be an integer greater than 1 and B is an integer greater than 1. For example, in response to analyzing the data structure of the first input, the input processor 104 can determine that the first input is comprised of 32-bits. Input processor 104 can determine or compute a difference between the number of bits in the first input and the number of bits for the fixed bit-width of the hardware circuit.

The input processor 104 can generate a signed multiword number based on the computed difference. In some implementations, each word of the signed multiword number is generated using a portion of bits that form the 32-bit data structure of the first input 102. For example, the signed multiword number can be formed from four 8-bit numbers or two 16-bit numbers. These numbers can correspond to the signed multiword numbers 106 and 108 described above. In some cases, each word of the signed multiword number is a signed word that includes a portion of bits from the first input and a corresponding sign-bit that denotes a sign of the signed word that forms the signed multiword number.

In some implementations, when a shifted signed multiword number is formed from four 8-bit numbers, this shifted signed number includes N=4 words, where each N word includes B=8 bits. This “shifted signed N-word B-bit number,” is represented by N ordinary signed numbers, each of bit-width B. By way of example, let a0, a1, . . . , a{N−1} be those ordinary signed numbers, and let a be the shifted signed number that each number together represents. A numerical value a of the shifted signed number is defined to be: a=a0+a1*2^{B}+a2*2^{(2B)}+ . . . +a{N−1}*2^{{(N-1)B}}, where a represents a respective signed word of the signed multiword input. The individual words a0, a1, . . . , a{N−1} are each signed numbers. In some other implementations, an original input number is zero-extended (e.g., ‘0’ bits are added at the most significant end) or sign-extended (e.g., the most significant bit of the original input number is copied to the excess bits) until the bit width is a multiple of B.

As discussed above, a data format may have a finite range of numerical values that can be represented using the data format. In some implementations, the shifted signed multiword number has a representable numerical range that is defined based on an example known expression for representing numerical ranges of ordinary two's complement numbers, but that includes an additional parameter S. The numerical range of the shifted signed multiword number is obtained using: [−2^{(N*B-1)}−S, 2^{(N*B-1)}−1−S]. The parameter S introduces a shift function to the known expression for representing numerical ranges for two's complement numbers. For example, when B=8 and N=2, the ordinary two's complement numbers have a representable range that is: [−32,768, 32,767]. This range for the ordinary two's complement numbers is obtained using the known expression: [−2^{(N*B-1)}, 2^{(N*B-1)}−1]. Regarding the unique data format described in this document, the parameter S is used to shift the known expression to the left (e.g., towards negative infinity) by a distance S relative to the ordinary N-word*B-bit two's complement representable range. In some implementations, S and the corresponding shift is defined based on: 2^{(B-1)}*(1+2^{B}+ . . . +2^{{(N-2)B}}).

In some implementations, hardware circuit 100 and input processor 104 uses a quantization scheme to modify a data format of the first input based on the fixed bit-width of the hardware circuit. The quantization scheme is configured to modify the data format of the first input by generating respective word portions to represent the first input as the signed multiword input. For example, the data format for generating signed multiword numbers from parameter or kernel weight values for a neural network layer may be modified based on a particular quantization scheme, such that the parameters can be appropriately used to compute an output for the layer. For the generated signed multiword input, the total bit-width that includes each respective word portion can be equal to the fixed bit-width of the hardware circuit. In some implementations, the input processor 104 is configured to adjust certain software schemes to re-quantize or change the way parameters and weights are obtained and processed at the circuit 100.

The circuit 100 provides the signed multiword input and a signed second input to multiplication hardware for multiplication (306). The signed second input corresponds to the received second input. In some implementations, the second input can correspond to signed input that does not exceed a bit-width of the hardware circuit or another shifted signed multiword number. In some other implementations, the second input corresponds to a signed input that does exceed a bit-width of the hardware circuit such that the circuit 100 generates a signed multiword number from the second input.

The circuit 100 generates a signed product from the multiplication hardware using at least the first and second inputs (308). For example, the circuit 100 generates a signed product 116 or 118 in response to multiplying the shifted signed multiword number of the first input with the shifted signed multiword number of the second input. These shifted signed multiword inputs include multiple respective words and the multiplication circuitry 114 is configured to generate the signed product by multiplying each word of the signed multiword first input with each word of the signed multiword second input. An advantage of the shifted signed multiword numbers is that they can be multiplied without needing an unsigned hardware multiplier. For example, to compute the signed product 116 of two such numbers a and b:

a=a0+a1*2^{B}+a2*2^{(2B)}+ . . . +a{N−1}*2^{{(N-1)B}}

b=b0+b1*2^{B}+b2*2^{(2B)}+ . . . +b{N−1}*2^{{(N-1)B}},

the hardware circuit 100 computes the products of aᵢ*bⱼ, which can all be computed using signed hardware multipliers of circuit 100.

A number of embodiments have been described. Nevertheless, it will be understood that various modifications may be made without departing from the scope of the invention. For example, various forms of the flows shown above may be used, with steps re-ordered, added, or removed. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A hardware circuit for multiplying sets of inputs, the hardware circuit comprising:
processing circuitry that receives a first input and a second input, each of the first and second inputs having a respective bit-width, wherein the processing circuitry is configured to represent at least the first input as a signed multiword input based on the first input having a bit-width that exceeds a fixed bit-width of the hardware circuit; and
one or more signed multipliers, each of the one or more signed multipliers being configured to multiply two or more signed inputs, each signed multiplier comprising multiplication circuitry configured to:
receive the signed multiword input that represents the first input;
receive a signed second input that corresponds to the second input; and
generate a signed output in response to multiplying the signed multiword input with the signed second input.

2. The hardware circuit of claim 1, wherein:
the signed multiword input is a shifted signed number comprising N words, each N word comprising B bits; and
N is an integer greater than 1 and B is an integer greater than 1.

3. The hardware circuit of claim 2, wherein a numerical value of the shifted signed number is defined based on: a0+a1*2^{B}+a2*2^{(2B)}+ . . . +a{N−1}*2^{{(N-1)B}}, wherein a represents a respective signed word of the signed multiword input.

4. The hardware circuit of claim 3, wherein a representable numerical range of the shifted signed number is defined based on: [−2^{(N*B-1)}−S, 2^{(N*B-1)}−1−S].

5. The hardware circuit of claim 3, wherein S is defined based on:
2^{(B-1)}*(1+2^{B}+ . . . +2^{{(N-2)B}}).

6. The hardware circuit of claim 1, wherein the processing circuitry is configured to represent the first input as a signed multiword input comprising:
a signed high-word portion; and
a signed low-word portion.

7. The hardware circuit of claim 6, wherein representing the first input as the signed multiword input comprises:
using a quantization scheme to modify a data format of the first input based on the fixed bit-width of the hardware circuit.

8. The hardware circuit of claim 7, wherein:
the quantization scheme is configured to modify the data format of the first input by generating respective word portions to represent the first input as the signed multiword input; and
a total bit-width that includes each respective word portion is equal to the fixed bit-width of the hardware circuit.

9. The hardware circuit of claim 1, wherein:
the signed multiword input comprises multiple respective words; and
the multiplication circuitry is configured to generate the signed output by multiplying each word of the signed multiword input with each word of the signed second input.

10. The hardware circuit of claim 1, wherein:
the second input is a signed multiword input such that the signed second input comprises multiple respective signed words; and
the multiplication circuitry is configured to generate the signed output as a sum of respective products that are computed from multiplying each word of the signed multiword input with each signed word of the signed second input.

11. A method for multiplying sets of inputs using a hardware circuit, the method comprising:
receiving, by a processing circuit of the hardware circuit, a first input and a second input, each of the first and second inputs having a respective bit-width, wherein at least the first input has a bit-width that exceeds a fixed bit-width of multiplication hardware included in the hardware circuit, the multiplication hardware being used to multiply the first and second inputs;
generating, from at least the first input, a signed multiword input comprising a plurality of signed words that each have a plurality of bits, wherein a bit-width of the signed multiword input is less than the fixed bit-width of the multiplication hardware;
providing the signed multiword input and a signed second input to the multiplication hardware for multiplication, wherein the signed second input corresponds to the second input and has a bit-width that is within the fixed bit-width of the multiplication hardware; and
generating a signed output from the multiplication hardware using at least the first and second inputs.

12. The method of claim 11, wherein:
the signed multiword input is a shifted signed number comprising N words, each N word comprising B bits; and
N is an integer greater than 1 and B is an integer greater than 1.

13. The method of claim 12, wherein a numerical value of the shifted signed number is defined based on: a0+a1*2^{B}+a2*2^{(2B)}+ . . . +a{N−1}*2^{{(N-1)B}}, wherein a represents a respective signed word of the signed multiword input.

14. The method of claim 13, wherein a representable numerical range of the shifted signed number is defined based on: [−2^{(N*B-1)}−S, 2^{(N*B-1)}−1−S].

15. The method of claim 13, wherein S is defined based on:
2^{(B-1)}*(1+2^{B}+ . . . +2^{{(N-2)B}}).

16. The method of claim 11, wherein generating the signed multiword input includes representing the first input as a signed multiword input comprising:
a signed high-word portion; and
a signed low-word portion.

17. The method of claim 16, wherein representing the first input as the signed multiword input comprises:
using a quantization scheme to modify a data format of the first input based on the fixed bit-width of the hardware circuit.

18. The method of claim 17, further comprising:
modifying, based on the quantization scheme, the data format of the first input by generating respective word portions to represent the first input as the signed multiword input,
wherein a total bit-width that includes each respective word portion is equal to the fixed bit-width of the hardware circuit.

19. The method of claim 11, wherein the second input is a signed multiword input such that the signed second input comprises multiple respective words and the method further comprises:
generating, using a single signed multiplier of the multiplication hardware, the signed output as a sum of the respective products of multiplying each word of the signed multiword input with each word of the signed second input.

20. One or more non-transitory machine-readable storage devices of a hardware circuit and for storing instructions that are executable by one or more processing devices to cause performance of operations comprising:
receiving, by a processing circuit of the hardware circuit, a first input and a second input, each of the first and second inputs having a respective bit-width, wherein at least the first input has a bit-width that exceeds a fixed bit-width of multiplication hardware included in the hardware circuit, the multiplication hardware being configured to multiply the first and second inputs;
generating, from at least the first input, a signed multiword input comprising a plurality of signed words that each have a plurality of bits, wherein a bit-width of the signed multiword input is less than the fixed bit-width of the multiplication hardware;
providing the signed multiword input and a signed second input to the multiplication hardware for multiplication, wherein the signed second input corresponds to the second input and has a bit-width that is less than the fixed bit-width of the multiplication hardware; and
generating a signed output from the multiplication hardware using at least the first and second inputs.
